(19) United States
(12) Patent Application Publication
(10) Pub. No.: US 2024/0079973 A1
(43) Pub. Date: Mar. 7, 2024

(54) ENERGY HARVESTING ARRANGEMENT AND IMPROVEMENTS IN AND RELATING TO POWER MANAGEMENT

(71) Applicant: UNIVERSITY OF EXETER, Exeter (GB)

(72) Inventors: Zheng Jun CHEW, Exeter (GB); Yang KUANG, Exeter (GB); Tingwen RUAN, Exeter (GB); Meiling ZHU, Exeter (GB)

(21) Appl. No.: 18/262,446

(22) PCT Filed: Feb. 11, 2022
(86) PCT No.: PCT/GB2022/050380

§ 371 Date: Jul. 21, 2023

(30) Foreign Application Priority Data
Feb. 12, 2021 (GB) 2101976.5
Jan. 27, 2022 (GB) 2201057.3

(51) Int. Cl. H02N 2/18

(52) U.S. Cl. CPC H02N 2/186; H02N 2/181

(57) ABSTRACT

An energy harvesting device is described comprising a piezoelectric material element (22), a proof mass (18) moveable relative to the piezoelectric material element (22) and coupled to the piezoelectric material element (22) by a coupling arrangement such that movement of the proof mass (18) causes compression of the piezoelectric material element (22), wherein the proof mass (18) defines a cavity (20), the piezoelectric material element (22) being located, at least in part, within the cavity (20). A power management circuit (50) suitable for use therewith is also described, the circuit (50) comprising a configurable voltage amplification and rectification circuit and a mode control circuit operable to configure the configurable circuit to operate in a voltage amplification mode or in a rectification mode, the mode control circuit selecting the operating mode depending upon the input or output of the configurable circuit.

This invention relates to an energy harvesting arrangement and in particular to an energy harvesting device arranged to generate electrical energy from the movement of a proof mass as a result of the application of vibrations or accelerations and the like thereto. It also relates to a rectifier circuit suitable for use with such a harvesting device or with other forms of harvesting device and operable to permit the generation or harvesting of enhanced levels of useable output power.

A number of energy harvesting devices are known for use in generating or harvesting electrical energy using vibration as an input. By way of example, devices are known in which a proof mass is suspended using resilient springs, and is cooperable with a piezoelectric material such that movement of the proof mass as a result of external vibrations or movements and the like causes deformation of the piezoelectric material in a direction resulting in the generation of an electrical output therefrom.

Commonly known energy harvesting devices of this type tend to be relatively fragile and of relatively poor reliability. Consequently, they are unsuitable for use in a number of applications. It has been found that, at least to some extent, the fragility and poor reliability of the known arrangements stem from the piezoelectric material having a relatively low tensile strength and so being relatively easy to break if loadings are applied thereto other than in a direction serving to compress the material. Typically the tensile strength of a piezoelectric material element is in the region of 35-40 MPa, but the compressive strength thereof is in excess of 600 MPa.

Also, the power management or rectifier circuits used in associated with many known energy harvesting devices are of relatively poor suitability for use in those applications. By way of example, where a simple full wave rectifier used with a harvester at a time when the harvester output is relatively low will produce an insufficient output for use in many applications. However, using a voltage amplification circuit to combat this may result in the output being too high when the harvester output rises.

It is an object of the invention to provide an energy harvesting device designed to be of enhanced reliability. It is another object of the invention to provide a power management circuit suitable for use with an energy harvester whereby the useful output may be enhanced.

According to a first aspect of the invention there is provided a harvesting device comprising a piezoelectric material element, a proof mass moveable relative to the piezoelectric material element and coupled to the piezoelectric material element by a coupling arrangement such that movement of the proof mass causes compression of the piezoelectric material element, wherein the proof mass defines a cavity, the piezoelectric material element being located, at least in part, within the cavity.

In a number of typical designs of harvesting device, the proof mass is located above, below or to a side of the piezoelectric material element. A consequence of this is that the centre of mass of the proof mass is offset relative to the piezoelectric material element. Where the harvesting device is subject to vibrations, accelerations or the like in a direction having a component perpendicular to desired vibration input direction, the offset centre of mass results in the application of torque loadings to parts of the energy harvesting device that may result in damage being caused thereto. By locating the piezoelectric element within the cavity formed within the proof mass, such offsetting of the centre of mass relative to the piezoelectric material element can be avoided or reduced, reducing the risk of damage to parts of the energy harvesting device in such circumstances and so resulting in the device being better suited for use in a range of applications.

The coupling arrangement conveniently comprising a first and second linkages coupled to the proof mass and coupled to respective compression members located to opposing ends of the piezoelectric material element. In use, movement of the proof mass relative to the piezoelectric material element in a direction perpendicular to an axis of the piezoelectric material element causes movement of the compression members towards or away from one another as a result of the linkages connected therebetween, varying the compression of the piezoelectric material element and thereby generating an electrical output therefrom.

Preferably, the manner in which the proof mass is coupled to the piezoelectric material element is such that, throughout the permitted range of movement of the proof mass, the piezoelectric material element is under compression. By way of example, the harvesting device may include first and second clamp members between which the piezoelectric material element is located, the first and second clamp members being coupled to one another by a coupling element applying a clamping load to the clamp members to pre-stress the piezoelectric material element, placing the piezoelectric material element under compression throughout the range of movement of the proof mass.

The energy harvesting device preferably further comprises a housing within which the proof mass and piezoelectric material element are located. Preferably, the proof mass is supported within the housing by resilient spring means. The spring means supporting the proof mass allow the harvesting device to be used in any orientation.

Further linkages are preferably provided between the compression members and a part of the housing, for example a base part thereof.

Preferably a compressible damper member is provided between the proof mass and a part of the housing, for example a lid thereof, to damp movement of the proof mass when the proof mass moves beyond a predetermined point relative to the housing.

According to another aspect of the invention there is provided a power management circuit comprising a configurable voltage amplification and rectification circuit, a configurable boost converter for charging energy storage capacitor from low voltage and a configurable voltage conversion circuit that avoids the high-losses buck-boost mode when the input voltage is very close to the output voltage selecting the operating mode depending upon the input or output of the configurable circuit.

Preferably, the configurable voltage amplification and rectification circuit selects the operating mode depending upon the input to the configurable voltage amplification and rectification circuit, which is the output of the energy harvester to convert the alternating current (AC) electrical energy from the energy harvester to direct current (DC) energy suitable for powering electronic load. By way of example, if the input to the configurable voltage amplification and rectification circuit is below a predetermined threshold then the circuit may configure to operate in the voltage amplification mode, and if the input is greater than the predetermined threshold then the circuit may configure to operate in the rectification mode. In this manner, the output may be maintained within a range suitable for operation of equipment with this the circuit is used over an increased range of input levels.

In the voltage amplification mode, the configurable circuit is preferably configured as a voltage doubler. In the rectification mode it is conveniently configured as a full wave rectifier, preferably an active full wave rectifier.

The configurable voltage amplification and rectification circuit is preferably further configurable as a passive full wave rectifier, operating as such during a start up and/or when the input is too low to permit operation and control over active circuit components.

The power management circuit is conveniently used in conjunction with the harvesting device defined hereinbefore. It will be appreciated, however, that it may be used in conjunction with a number of other varying voltage sources including other forms of harvesting device.

The power management circuit converts the wide range of voltage from the energy harvester to a steady output voltage as required by the equipment used with this power management circuit. When the input voltage is lower than the required output voltage, boost conversion is performed. When the input voltage is higher than the required output voltage, buck conversion is performed. Conventional circuit also performs buck-boost conversion when the input voltage is very close to the required output voltage. However, buck-boost conversion is highly inefficient as it requires four switches for its operation, which has higher switching and conduction losses if compared with either the buck or boost conversion that only requires two switches. In this power management circuit, the buck-boost mode is eliminated by using the configurable voltage amplification and rectification circuit to amplify the input voltage to be higher than the required output voltage or switching from a voltage doubler to a full wave rectifier so that the input voltage without amplification is much lower than the required output voltage. By doing so, the input voltage will never be close to the required output voltage and therefore, buck-boost mode operation is not required.

According to another aspect of the invention, there is provided a system comprising the aforementioned circuit and the aforementioned energy harvesting device, the circuit configured to rectify the output thereof.

In an embodiment, the system may further comprise a storage capacitor, wherein the circuit may be configured to charge the storage capacitor.

In an embodiment, the system may further comprise a step-up converter, wherein the circuit may be configured to charge the storage capacitor by direct charging when an open circuit voltage of the energy harvesting device is below a threshold and the step-up converter may be configured to charge the storage capacitor when the open circuit voltage of the energy harvesting device is greater than or equal to the threshold.

In an embodiment, the circuit may be configured to charge directly the storage capacitor at around 75% of the peak open-circuit voltage of the energy harvesting device 0.75V_{g,OC}.

In an embodiment, the system may further comprise a further storage capacitor, wherein the system may be configured to charge one of the storage capacitor and the further storage capacitor in response to the other of the further storage capacitor and the storage capacitor being discharged by a load.

In an embodiment, the system may further comprise an analogue based wake-up circuit.

The invention will further be described, by way of example, with reference to the accompanying drawings, in which:

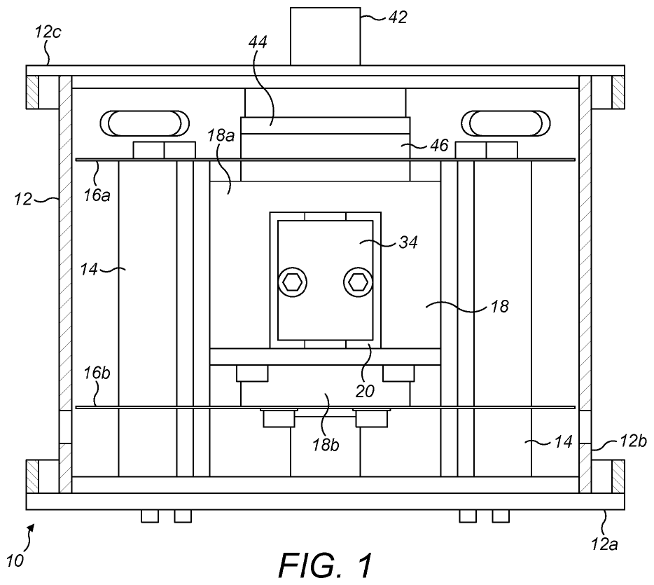

FIG. 1 is a sectional view illustrating a harvesting device in accordance with an embodiment of the invention;

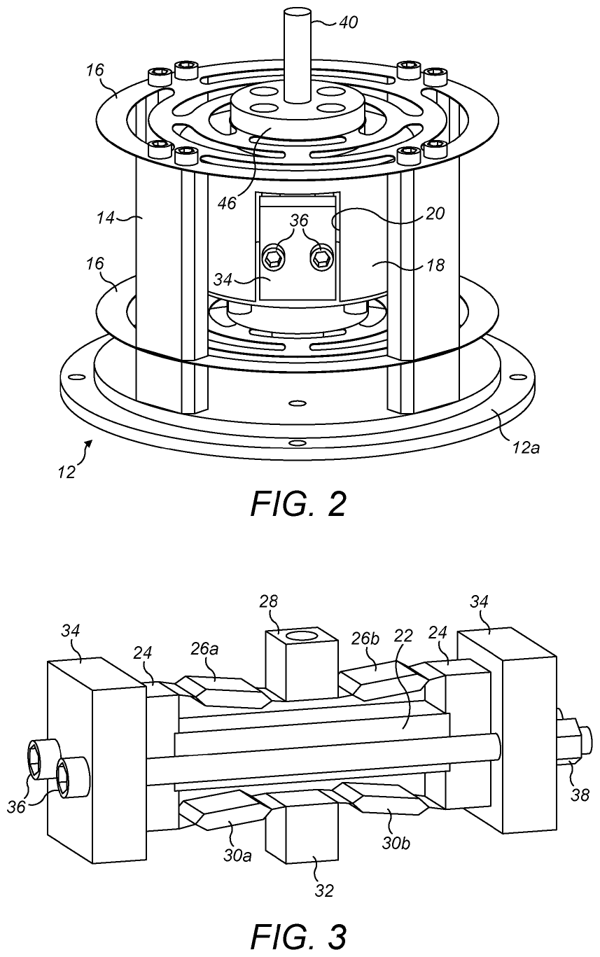

FIGS. 2 and 3 are views illustrating parts of the device of FIG. 1; and

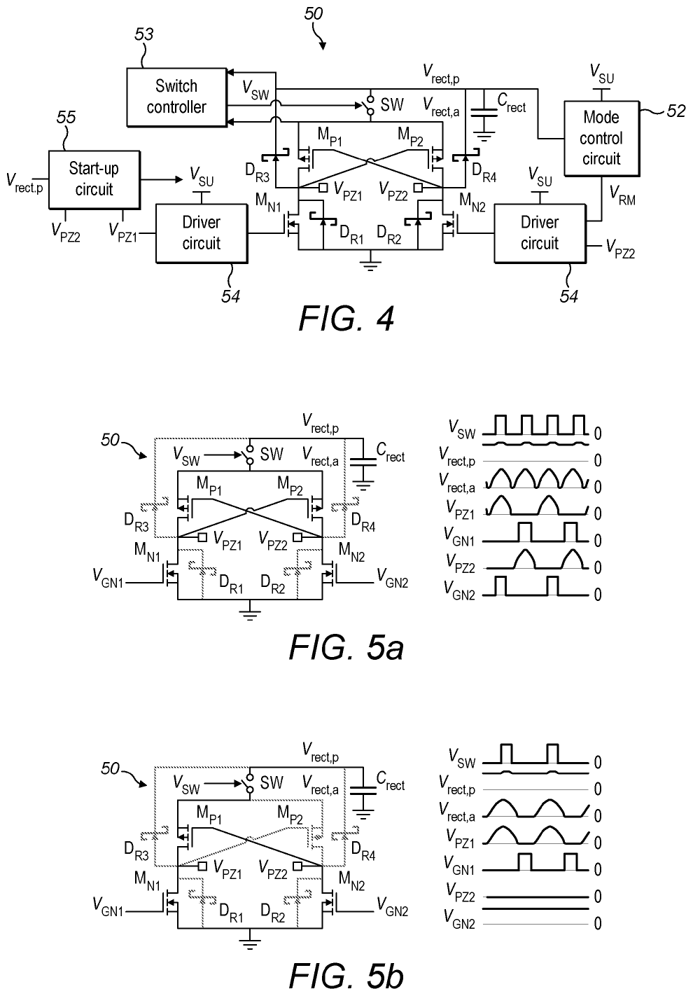

FIGS. 4 to 7 are a series of diagrammatic views illustrating a power management circuit in accordance with another embodiment of the invention, suitable for use in conjunction with the harvesting device of FIGS. 1 to 3.

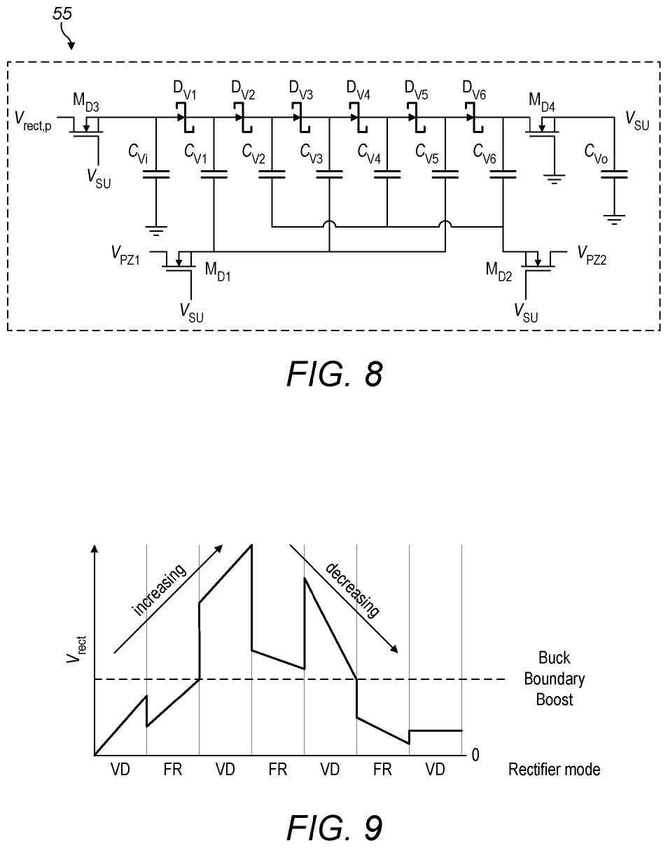

FIG. 8 is a circuit diagram of the start-up circuit of the power management circuit from FIG. 4.

FIG. 9 shows a voltage profile of how the rectifier mode changes as the rectified voltage, V_{rect}, changes.

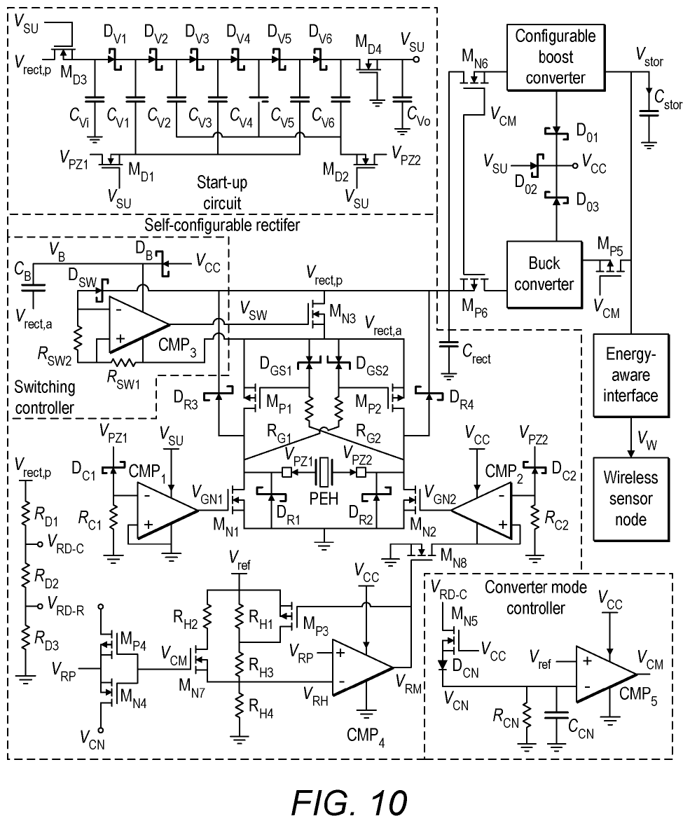

FIG. 10 shows a more detailed circuit diagram of the power management circuit that can operate from a very wide range of input voltage of around 0.35 V to any high voltage, which could be over 50 V as limited by the voltage rating of the components used.

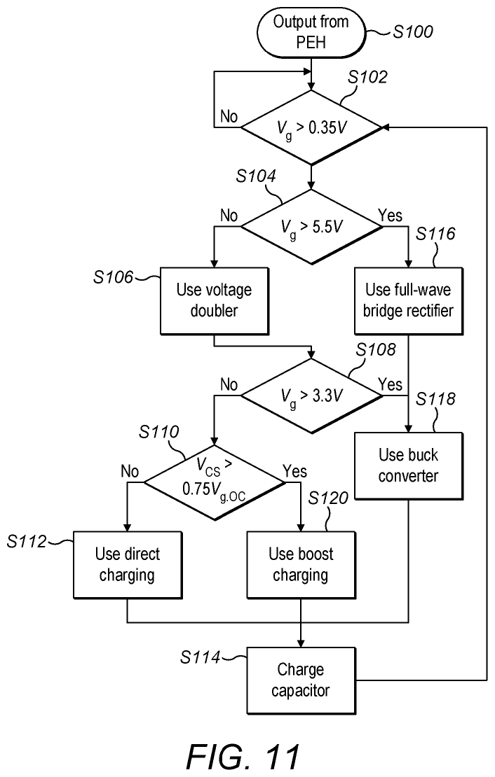

FIG. 11 shows a flow chart describing a mode of operation of the power management circuit from FIG. 10, according to an embodiment.

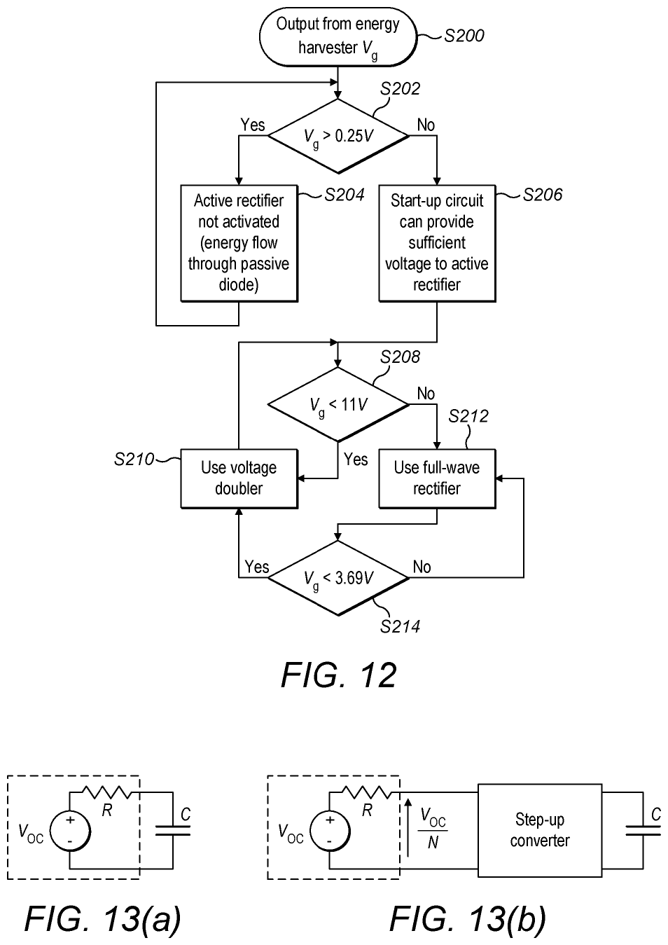

FIG. 12 shows a flow chart describing a mode of operation of the power management circuit from FIG. 10, according to another embodiment.

FIG. 13 shows a system diagram of the power management circuit from FIG. 10, a step-up converter and a storage capacitor to be charged.

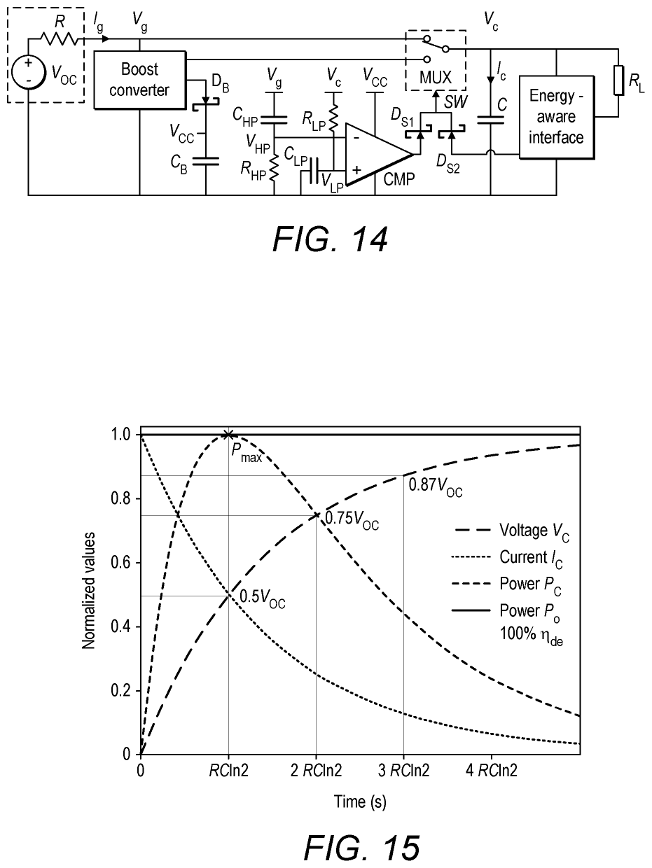

FIG. 14 shows a system similar to FIG. 13.

FIG. 15 shows a performance graph of the system from FIG. 13.

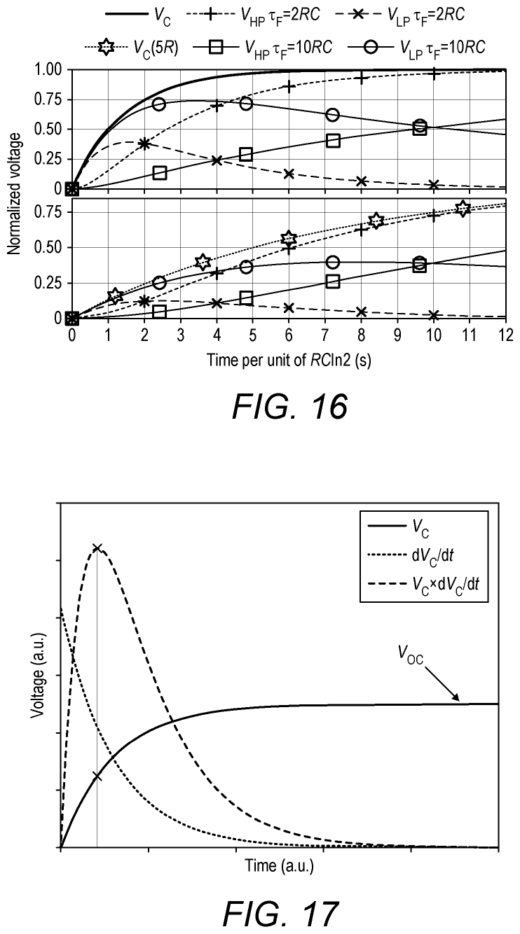

FIG. 16 shows a further performance graph of the system from FIG. 14.

FIG. 17 shows a voltage profile for an open circuit voltage of the energy harvesting device.

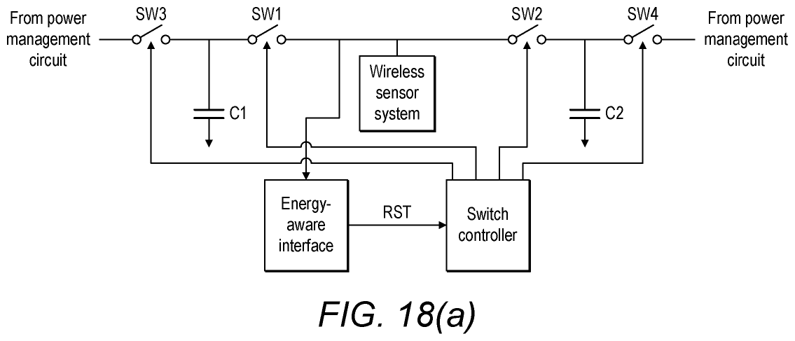

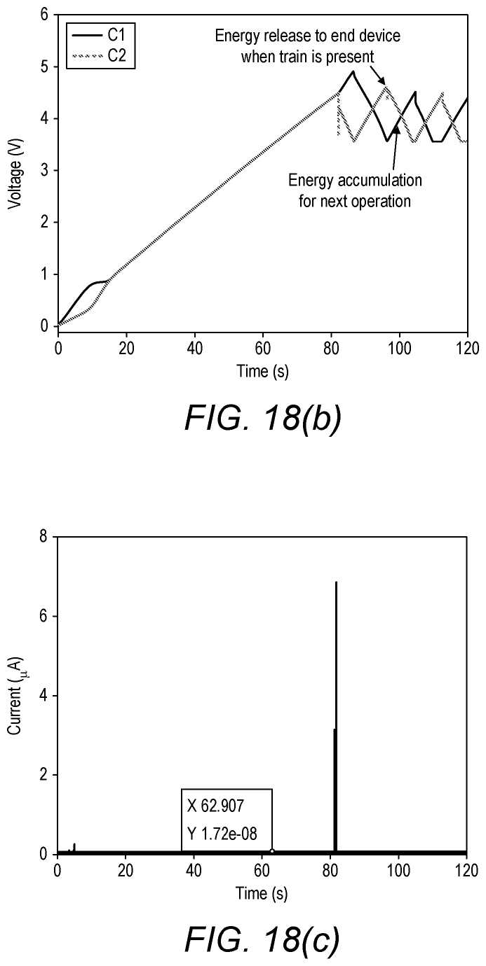

FIG. 18a shows a block diagram of a system including two storage capacitors, and FIGS. 18b and 18c show voltage and current profiles over time for charging and discharging the capacitors in operation.

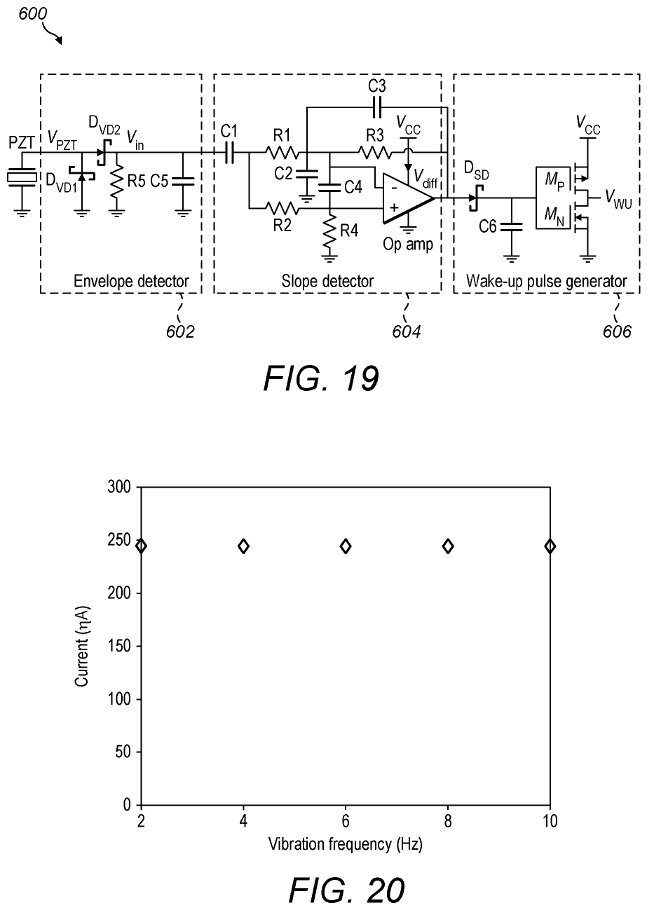

FIG. 19 shows a circuit diagram of a wake-up circuit for use with the system from FIG. 13.

FIG. 20 shows current versus vibration frequency for the performance of the wake-up circuit from FIG. 19.

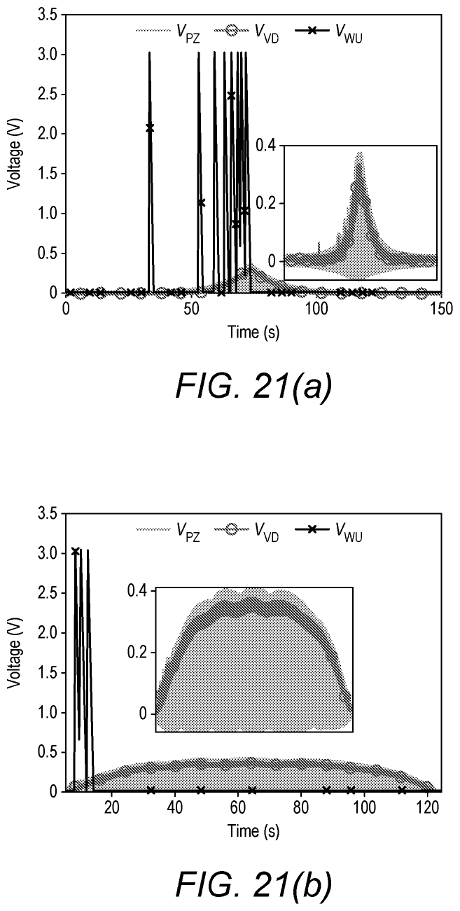

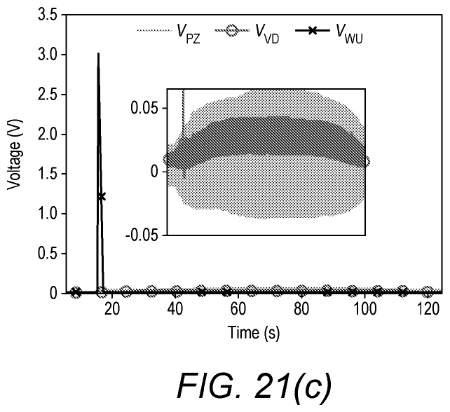

FIG. 21 shows graphs of the response of the circuit to signals with different profiles of a) increasing angle of inclination, b) decreasing angle of inclination, and c) decreasing angle of inclination with very low amplitude of less than 100 mV.

Referring firstly to FIGS. 1 to 3 of the accompanying drawings, an energy harvesting device 10 is illustrated comprising a multipart housing 12 including a base 12a, side wall 12b and lid 12c, the housing 12 being of generally cylindrical shape. Secured to the base 12a and located within the housing 12 are four support posts 14. The support posts 14 carry a pair of plate spring 16a, 16b that carry a proof mass 18 so that the proof mass 18 is supported within the housing 12 but is able to undertake limited axial movement within the housing 12.

The proof mass 18 is of two part form, comprising a main part 18a of generally cylindrical form and in which a diametrically extending cavity 20 is formed, and a disc-like part 18b bolted to the underside of the main part 18a.

The energy harvesting device 10 further comprises a piezoelectric material element 22 of generally cuboid shape that is located within the cavity 20, extending generally in the direction of the axis thereof, and sandwiched between a pair of compression members 24. The compression members 24 are connected by first and second upper linkages 26a, 26b to an upper connector 28 secured, in use, to the proof mass 18, and by first and second lower linkages 30a, 30b to a lower connector 32 that extends through an opening in the disc-like part 18b and is secured to a central projection formed on the base 12a.

It will be appreciated that, in use, in the event of a vibration or acceleration being applied to the housing 12 causing movement of the proof mass 18 towards the base 12a accommodated by flexing of the plate springs 16a, 16b, and relative movement of the connectors 28, 32 towards one another, the upper and lower linkages 26a, 26b, 30a, 30b will convert the motion into movement of the compression members 24 towards one another, increasing the compression of the piezoelectric material element 22 and causing the output of an electrical signal therefrom. Similarly, movement of the proof mass 18 in the opposite direction, away from the base 12a, will cause movement of the compression members 24 away from one another, reducing the compression of the piezoelectric material element 22.

As best shown in FIG. 3, the compression members 24 and piezoelectric material element 22 are located between a pair of clamp members 34, and long bolts 36 extend through aligned openings in the clamp members 34 and have nuts 38 cooperating therewith serving to apply a clamping load to the clamp members 34, precompressing the piezoelectric material element 22, such that the piezoelectric material element 22 has a compressive load applied thereto at all times throughout the operation of the energy harvesting device 10.

A stud including an axially extending shaft 40 is carried by the proof mass 18, the shaft 40 projecting through an opening provided in the lid 12c and into a linear bearing 42 carried by the lid 12c. Also carried by the proof mass 18 is an elastomeric material damper member 44, a spacer disc 46 being provided between the damper member 44 and the proof mass 18. The dimensions of the spacer disc 46 are chosen such that as the proof mass 18 is approaching an end of a permitted range of movement away from the base 12a, the damper member 44 comes into contact with the underside of the bearing 42 or the lid 12c and compresses to slow and stop movement of the proof mass 18 in this direction.

In use, as mentioned hereinbefore, upon a generally axially directed vibration or acceleration being applied to the housing 12, the proof mass 18 will move axially within the housing 12 as permitted by the plate springs 16a, 16b, and the resulting relative movement of the connectors 28, 32 is transmitted through the linkages 26a, 26b, 30a, 30b to change the level of compression of the piezoelectric material element 22, causing the generation of an electrical output. If the vibration or acceleration is sufficiently violent that the proof mass 18 approaches the end of its permitted range of movement, the movement of the proof mass 18 within the housing 12 is damped as a result of contact of the damper member 44 with the linear bearing 42 or lid 12c.

In the event that the housing 12 is subject to a vibration or acceleration in a lateral direction, the fact that the piezoelectric material element 22 is located within a cavity formed in the proof mass 18 serves to ensure that the centre of mass of the proof mass 18 is substantially aligned with the piezoelectric material element 22, and the application of a torque to the connectors 28, 32 that could cause damage thereto is avoided. Furthermore, the plate springs 16a, 16b are designed in such a manner as to prevent or significantly limit lateral movement of the proof mass 18 as a result of the application of such vibrations, and the location of the shaft 40 within the linear bearing 42 serves to limit lateral movement of the proof mass 18 within the housing 12, limiting movement of the proof mass 18 to substantially axial movement. By limiting the application of lateral loadings to the connectors 28, 32 other than in the axial direction thereof, it will be appreciated that the risk of damage thereto, in use, is reduced or removed altogether, and so the lifespan thereof is increased. The design is further advantageous in that the device 10 is of a compact form.

The clamp members 34 and nuts 38 and bolts 36 serve to ensure that the piezoelectric material element 22 is always under compression. The risk of damage to the energy harvesting device as a result of the piezoelectric material element being placed under tension is thus reduced or avoided. The compressive stress applied continuously to the piezoelectric material element 22 can further allow the piezoelectric element 22 to operate at a higher stress level to produce a higher output and an increased operating lifespan.

It will be appreciated, therefore, that the energy harvesting device is of a good level of robustness and so is suitable for use in a wide range of applications.

As the proof mass 18 is suspended within the housing 12 by the plate springs 16a, 16b, it will be appreciated that the energy harvesting device 10 can be used in any orientation, and not just in the orientation shown in the drawings. Again, this results in the device 10 being suitable for use in an increased range of applications. It will be appreciated that, in use, the energy harvesting device 10 may be subject to accelerations or vibrations applied in directions other than those mentioned hereinbefore, and that the device 10 will operate to guard against or reduce the risk of damage arising from the components of those vibrations or accelerations in directions other than the axial direction in which the proof mass 18 is intended to be moved, and will generate an electrical output in response to the components of those vibrations that are in the axial direction in which the proof mass 18 is intended to be moved, in use.

The output from the device 10 described hereinbefore is preferably supplied to a power management circuit 50 of the type shown diagrammatically in FIG. 4. The circuit 50 includes a passive diode based rectifier circuit in parallel with an active or configurable rectifier circuit that can switch its topology or configuration between a voltage amplification mode and a rectification mode, a control circuit 52 that configures and switches the rectifier topology or configuration between these modes, two driver circuits 54 to switch the NMOS of the active rectifier circuit, and a start-up circuit. The circuit operation, function and switching mechanism is set out below.

The outputs from the device 10, with the voltages V_{PZ1} and V_{PZ2} respectively, are connected to the circuit 50 as shown. The passive rectifier and active rectifier are connected in parallel as illustrated. Assuming that the circuit is starting up for the first time or from another condition in which substantially no energy is stored in its energy storage capacitors, the voltage from the device 10 will be rectified by the passive rectifier formed by four Schottky diodes, D_{R1-4}. The rectified voltage V_{rect} is fed into the start-up circuit, which is a charge pump driven directly by the device 10. Once the output voltage of the charge pump is sufficiently high to startup the driver circuits 54, the active rectifier circuit will be operating in a voltage amplification mode, in this case voltage doubler (VD) mode, by default unless the output voltage from the device 10 is sufficiently high to allow direct operation in the rectifier mode. The active rectifier circuit in VD mode gives a higher rectified voltage to succeeding circuits that are connected to the output of the active rectifier circuit for an easier start-up in case of a low device 10 voltage. The switching from one topology to another is determined by the voltage requirement and limit of the succeeding circuits at the output of the active rectifier circuit 50. The control circuit 52 monitors V_{rect} to decide the topology or mode to be used. The active rectifier circuit 50 switches to full-wave rectifier (FR) mode when V_{rect} is sufficiently high as further voltage amplification in VD mode will be too high for the succeeding circuits at the output of the circuit 50 and switches back to VD when V_{rect} becomes too low.

FIG. 5 illustrates the components in use and some key voltage waveforms of the rectifier in FR and VD modes. The active rectifier is formed by two gate cross-coupled PMOS M_{P1,2} that are driven by V_{PZ} and two NMOS M_{N1,2} that are driven by driver circuits with the output voltages V_{GN1} and V_{GN2} applied to the gates of M_{N1} and M_{N2}, respectively. There is a switch SW to prevent direct connection between the outputs of the passive and active rectifiers for proper operations of the rectifying circuit. The switch is turned on by the signal V_{SW} when the output of the active rectifier V_{rect,a} is higher than the passive rectifier V_{rect,p}. When the switch is closed, the passive rectifier and active rectifier are in parallel but the FR is the dominating element in rectifying ac voltage as the MOSFETs provide a current path with a lower voltage drop than V F of the diodes that form the passive rectifier. The switch is open to prevent energy backflow from the smoothing capacitor C rect when V_{rect,a} is lower than Vrect,p. When operating in the FR mode, MP1 and MN2 are used to rectify the half cycle of the device 10 output voltage when VPZ1>0 while MP2 and MN1 are used for the other half cycle when VPZ2>0.

To operate in the VD mode, NMOS MN2 is constantly turned on to bypass diode DR2. Thus, the anode of DR4 and the terminal of the device 10 at VPZ2 are pulled to ground. As Crect tends to hold charges at the output of the rectifier, there is usually a positive voltage at the cathode of D_{R3} and D_{R4}. Thus, D_{R4} can be regarded as open circuited since it is reverse biased by the voltage at its cathode and ground connection at its anode. M_{P1} is always turned on as its gate is connected to V_{PZ2}, which is always LOW. This in turn connects the source and gate of M_{P2} together, which makes M_{P2} always off. As V_{PZ1} goes to zero, V_{GN1} from the driver circuit turns HIGH to turn on M_{N1} to charge up the intrinsic capacitor of the device 10. As the piezoelectric voltage increases again, the energy from the PEH is transferred to the output of the rectifier via M_{P1} and SW, which will be toggled as explained above. D_{R1} and D_{R3} are still a valid current path in VD mode but as in the case of the FR mode operation, M_{P1} and M_{N1} are the dominating elements, which without VF provide a lower loss current path than the diodes.

Low power is one of the main considerations as most of the harvested energy should be for the end device instead of being used by the interface circuit. Thus, different voltage regulation methods are used in the rectifier, driver circuit, start-up circuit, and control circuit that all have different operating conditions. The voltage regulators will be presented as part of the individual subsystems.

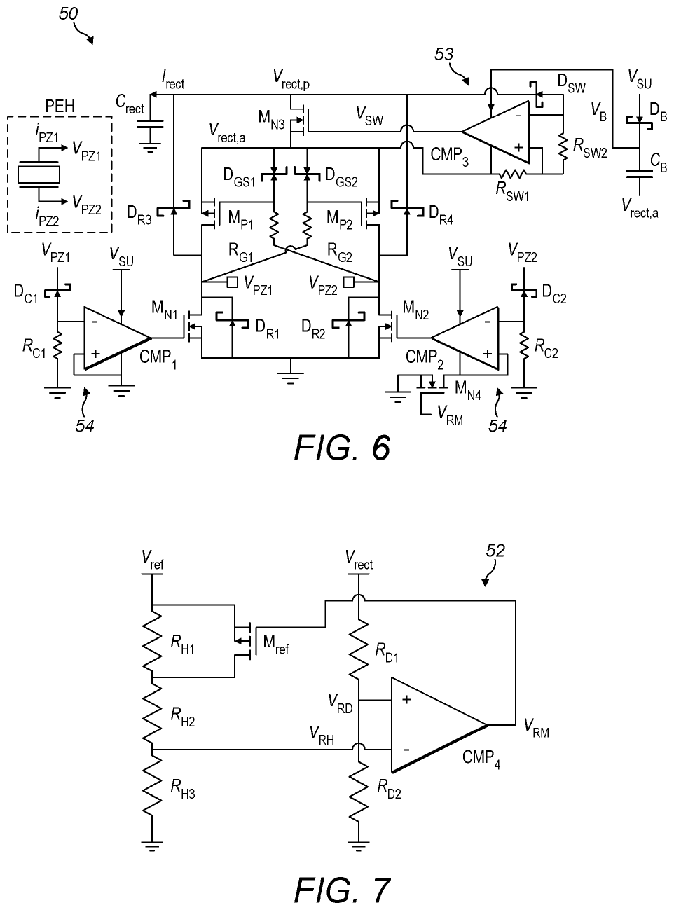

Apart from D_{R1-4}, M_{P1,2}, and M_{N1,2}, resistors R_{G1,2} and gate protection diodes D_{GS1,2} are also conveniently part of the rectifier circuit 50 as shown in FIG. 6 to protect M_{P1,2}. A MOSFET may have a high drain-source voltage VDS rating but its gate-source voltage V_{GS} rating is usually much lower. The possible high voltage from the device 10 may cause V_{rect,a} at the source of M_{P1,2} to be high and the high voltage is held by C_{rect}. In the conventional cross-coupled connection, the gate of the PMOS at one side is connected directly to the terminal of the device 10 at the other side as shown in FIGS. 4 and 5. Thus, the voltage applied to the gate is V_{PZ}, which can be slightly lower than zero at its trough. With V_{rect,a} remains high due to C_{rect}, V_{GS} can be very high that it exceeds the breakdown V_{GS} of M_{P} and permanently damages M_{P}. With a D_{GS} in between the source and gate of M_{P} and a R_{G} between the gate and the ground as shown in FIG. 6, the gate voltage V_{G} of M_{P} no longer goes to a very low voltage that creates a high V_{GS}. D_{GS} suppresses V_{GS} to be within its clamping voltage if V_{GS} exceeds that voltage. The gate voltage of M_{P} drops across R_{G}. Thus, an appropriate value of R_{G} is required to reduce power dissipation without affecting the switching of M_{P} as R_{G} forms an RC circuit with the parasitic capacitance of M_{P}. The RC time constant needs to be much shorter than the period of the vibration applied to the PEH for a proper operation.

The switch SW is realized by an NMOS M_{N3}, which has its drain and source connected to the output of the passive and active rectifiers, respectively. Since the voltage at the source of M_{N3} is V_{rect,a}, M_{N3} is turned off when the voltage applied to its gate equals V_{rect,a}. To turn on M_{N3}, the voltage applied to its gate has to be at least V_{rect,a} plus the threshold voltage V_{TH} of M_{N3}. A switch controller that comprises a comparator CMP₃, a diode D_{SW}, and two resistors R_{SW} is used to toggle M_{N3}. CMP₃ is driven by using a bootstrap capacitor power supply that is referenced to V_{rect,a}. The start-up circuit charges up the bootstrap capacitor C_{B} to voltage V_{SU} via diode D_{B} when V_{rect,a} reaches its trough. As V_{rect,a} increases, the voltage V_{B} across C_{B} increases accordingly to a level that is equal to V_{SU} plus V_{rect,a} minus V_{F} of D_{B} to power up CMP₃. With the ground pin of CMP₃ at V_{rect,a}, this gives CMP₁ an output voltage of higher than V_{rect,a} by V_{SU} minus V_{F} to fully turn on M_{N1} and a LOW output voltage of V_{rect,a}, which is low enough to turn off M_{N3}.

The positive input of CMP₃ is biased at the voltage V_{rect,a} via R_{SW1}. The negative input is linked to V_{rect,a} via R_{SW2} and V_{rect,p} via D_{SW}. D_{SW} is reverse biased when V_{rect,a} is lower than V_{rect,p}. Thus, the voltage at the negative and positive inputs are equal at V_{rect,a} for CMP₃ to output a voltage V_{SW} that is LOW to keep M_{N1} Off. When V_{rect,a} becomes higher than V_{rect,p}, D_{SW} is forward biased and conducts current. This causes the voltage at the negative input to become slightly lower than the positive input due to the voltage drop across RSW2. Thus, the switching voltage VSW becomes HIGH to turn on MN3. As the inputs and ground of CMP3 and CB are referenced to Vrect,a, a low voltage comparator can be used to implement CMP3.

As mentioned above, conventional active rectifiers connect the negative input of the comparator directly to the supply source. The operating voltage range of such a design is limited by the breakdown voltage of the comparator, which the supply voltage cannot exceed. The comparator turns on the NMOS whenever the voltage of the device 10 at its negative input goes to zero or below as shown in FIG. 5. Since the comparator turns on the NMOS when the device 10 voltage is LOW, the high voltage of the device 10 is not needed and can be decoupled from the comparator. The proposed driver circuit uses a resistor R_{C} and a diode D_{C} with its anode connected to the negative input of CMP_{1,2} to isolate the high voltage. The other end of R_{C} is connected to the ground and the cathode of D_{C} is connected to the terminal of the device 10. D_{C} is reverse biased when V_{PZ} is higher than its V_{F} since its anode is connected to the ground via R_{C}. Thus, D_{C} can be regarded as open-circuited, which prevents very high V_{PZ} to be directly applied to the negative input of CMP and damage it. Before M_{N1,2} are switched on, D_{R1,2} are the current path due to their lower VF than the inherent body diode of MOSFETs. Thus, the trough of VPZ will go below zero to −VF. This causes D_{C} to be forward biased, which applies a negative voltage at the input of CMP. With the positive input of CMP1,2 at zero, which is higher than the negative voltage, CMP1,2 output a HIGH signal VGN1,2 to turn on MN1,2. Thus, this circuit design allows an active rectifier to be implemented using low voltage comparators regardless of the high device 10 voltage.

The positive input and ground terminal of CMP2 are joint together and floated when the circuit first start-up. They are disconnected from the system ground by MN4, which is in an OFF state initially. The floating voltage at the positive input of CMP₂ is always higher than the negative input that is pulled to ground by R_{C2}. Thus, CMP₂ has an always-HIGH output that constantly turns on M_{N2} for a VD topology by default. M_{N4} will be turned on by the control circuit when V_{PZ} is sufficiently high to connect the negative input and ground pin of CMP₂ to the system ground. CMP₂ will then operate as described in the earlier paragraph where it turns on M_{N4} for the rectifier to operate as a FR when V_{PZ2} reaches its trough.

The mode control circuit is shown in FIG. 7, which consists of a comparator CMP₄, a PMOS M_{ref}, and some resistors. Resistive voltage dividers are used to scale down V_{rect} and a reference voltage V_{ref} to an appropriate ratio as V_{RH} at the negative and V_{RD} at the positive inputs of CMP₄, respectively. V_{RH} is lower than V_{RD} in VD mode and vice versa in FR mode for CMP₄ to output V_{R}M that toggle MN4 as explained above and Mref for switching the rectifying topology as Vrect reaches a threshold. Switching Mref on and off leads to the rectifier operation as a VD and FR, respectively.

As the rectifier switches from VD mode to FR mode, Vrect and hence VRD reduce by half. If VRH is unchanged, it could be higher than V_{RD}, causing CMP₄ to output a LOW signal that switches the circuit to operate as a VD mode again and amplify V_{rect}. This will triggers the circuit to switch back to FR mode again and the cycle repeats, alternating between the two rectifying modes in an unstable state. Thus, the value of V_{RH} needs to be adaptive to the rectifying mode. The reference in VD mode V_{RH-VD} has to be higher than the one in FR mode V_{RH-FR}, which decreases as V_{RD} is halved. This is achieved by a recofigurable resistive divider network formed by R_{H1-3} and M_{ref}. When M_{ref} is turned on in VD mode, it acts as a closed switch to bypass the resistor R_{H1}. Thus, V_{RH-VD} is given as (1):

$${V}_{RH - VD} = \frac{{R}_{H 3}}{{R}_{H 2} + {R}_{H 3}} {V}_{ref} \qquad ( 1 )$$

When M_{ref} is turned off, it is does not have any effect on the resistive divider network. Thus, V_{RH-FR} is expressed as (2):

$${V}_{RH - FR} = \frac{{R}_{H 3}}{{R}_{H 1} + {R}_{H 2} + {R}_{H 3}} {V}_{ref} \qquad ( 2 )$$

Equation (1) slightly differs from equation (2) in the denominator where R_{H1} is excluded from (1) as M_{ref} is switched on as explained earlier. Thus, V_{RH-VD} is higher than V_{RH-FR} because of its smaller denominator. When M_{P3} is turned off in FR mode, R_{H1} is included in the voltage divider to reduce V_{RH} as V_{RD} is lowered due to the switching from VD mode to FR mode to prevent the constant mode toggling issue.

The voltage regulation methods applied as set out hereinbefore are not used here as they isolate high voltage from the circuits or limit the voltage intake, which does not allow the scaling of the voltage. Although it is possible to use a resistive voltage divider in the other circuits, they are not ideal as the resistive networks continually dissipates power. Also, when the PEH voltage is very low, the scaled down voltage will be even lower, which might not be recognized by the comparators as a valid signal.

A self-powered and self-configurable active rectifier circuit 50 for energy harvesters with a wide voltage range is thus described hereinbefore. The circuit 50 is able to startup from low output voltage of an energy harvester and operates using VD topology by default to boost the voltage. Even though the voltage of the energy harvester is low, the voltage that has been amplified would be sufficiently high to reach the gate threshold voltage of the MOSFETs used as the rectifier. This allows the rectifier to operate at a higher efficiency and wider range than conventional active rectifiers that operate using a fixed topology. The circuit switches its topology to a FR mode, which does not amplify the voltage as the voltage of the energy harvester becomes sufficiently high. Low power and voltage comparators were used as driver and control circuits. Novel voltage regulation using a resistor and a diode was introduced for the comparators to operate using the high voltage from the energy harvester as the input signal. The circuit was tested using the strongly coupled harvester device and achieved voltage and power conversion efficiencies of over 90% in most of the tested conditions.

It will be appreciated that through the use of the circuit 50, the useful output of the device 10 can readily be enhanced through operating in VD mode when the device 10 output is low, switching to FR mode when the output is higher, switching depending upon the requirement of equipment with which the circuit 50 is to be used.

It will be appreciated that the circuit 50, whilst described herein as used in conjunction with the output of the device 10, could be used in conjunction with a range of other varying voltage sources, for example other forms of vibration or motion based energy harvester devices. The invention is not restricted to the use of the circuit 50 with the specific source set out hereinbefore.

FIG. 8 shows a circuit diagram of the start-up circuit from FIG. 4. The start-up circuit is in the form of a charge-pump.

The start-up circuit includes Schottky diodes D_{V1-6}, flying capacitors C_{V1-6}, four MOSFETs M_{D1-4}, and filter capacitors C_{Vi} and C_{Vo}, as shown in FIG. 4. M_{D1-4} are used as the voltage regulator here by applying a regulating voltage at their gate. M_{D1-4} are turned on when the applied V_{GS} V_{TH} of M_{D}. The voltage relationship can be rewritten as (3) and rearranged as (4). The applied gate voltage V_{G} limits the maximum voltage V_{S} that can present at the source terminal of M_{D}. M_{D1-3} limit the voltage intake of V_{PZ} and V_{rect,p}, which can be very high. M_{D4} further limits the output from the charge pump to ensure V_{SU} is always within a safe level for the circuits.

V_{G}−V_{S}≥V_{TH} (3)

V_{S}≤V_{G}−V_{TH} (4)

The circuit has an even number of stages n with each D_{V}-C_{V} pair forming a multiplier stage. The start-up circuit takes V_{rect,p} as its input with the PEH driving its flying capacitors C_{V} to provide an amplified voltage V_{SU} and current I_{SU} as in (5) for starting-up the driver and control circuits. The source voltages V_{S-MD3} of M_{D3} and V_{FLY} of M_{D1,2} are equal to V_{rect,p} and V_{PZ}, respectively, if they are lower than the condition on the right of (4). Otherwise, the voltages are limited by the V_{G} applied and V_{TH} of M_{D}. Since the flying capacitors are driven directly by V_{PZ}, f_{PZ} is the vibration frequency of the PEH.

V_{SU}=V_{S-MD3}−V_{F-DV}+n(V_{FLY}−V_{F-DV})−nI_{SU}(C_{V}F_{pz})⁻¹ (5)

Depletion-mode MOSFETs are used as M_{D1-4} as they are normally closed devices that allow current flow even when V_{G} applied to their gate is zero to enable cold start-up of the circuit. However, their channel resistance is usually higher than enhancement-mode MOSFETs such as M_{P1,2} and M_{N3,4}. By taking one stage that is formed by C_{V1} and D_{V1} as an example, C_{V1} will be charged up to a voltage that is equal to V_{rect,p} minus V_{F} of D_{V1} and the voltage drop of M_{D3}, and then boosted by V_{PZ1} minus the voltage drop of M_{D1}. The voltage drop of M_{D} increases with their resistances, which reduces the peak voltage at each stage and the output voltage of the start-up circuit. Thus, V_{SU} is applied to the gate of M_{D13} to reduce their resistance for a higher V_{SU}. Depletion-mode MOSFETs have a negative V_{TH} where V_{G} has to be lower than V_{S} to meet the condition as given by (3). Instead of generating a negative V_{G} using an additional circuit, which consumes more power, C_{Vi} and C_{Vo} are used to hold the voltage at the source of M_{D3,4} so that the minimum V_{G} can simply be zero to limit the voltage at the source of M_{D} to a voltage that is equal to the V_{TH} of M_{D}. A diode in between C_{Vn} and C_{Vo} to prevent backflow of the charges is not required in this design. When the rectifier is in FR mode, the amplitude of V_{PZ} is sufficiently high where the voltage at C_{Vn} has already exceeded V_{SU}, which is regulated by M_{D4}. In VD mode, the even-number stages are not acting as the multiplying stage because V_{PZ2} is at the ground. Thus, D_{Vn} at the last stage directly acts as the blocking diode here.

FIG. 9 shows a voltage profile showing how the rectifier and converter are used as V_{rect} changes.

The rectifier is a VD by default to amplify the voltage from the energy harvester V_{EH} to output a higher V_{rect} to succeeding circuits such as the start-up circuit and boost converter for an easier start-up and operation at a higher efficiency. When V_{EH} is sufficiently high, the rectifier reconfigures to a FR that does not amplify V_{rect} to prevent giving a very high voltage that damages the succeeding circuits. Assuming that the boost converter is in use, the circuit will switch to the buck mode with further increment of V_{rect}. The rectifier reconfigures to a VD during this transition to amplify V_{rect} so that the voltage exceeds or meets the minimum operating voltage of the buck converter. When V_{rect} is too low for the buck converter, the rectifier reconfigures to a FR as the circuit switches to boost mode. This introduces a wider gap in V_{rect} for using the boost or buck converters as shown in FIG. 9. This eliminates the need for a buck-boost converter and instability to the circuit of keeping switching between the boost and buck modes when V_{rect} is near to the switching boundary.

FIG. 10 shows a detailed circuit diagram of the power management circuit. Also shown in FIG. 10 is a wireless sensor being supplied with power from the power management circuit via a buck-boost converter. Also shown are an energy storage capacitor Cₛₜₒᵣ, and an energy-aware interface (EAI). Since the constituent components of the circuit have been described above, duplicate description will be omitted for the sake of brevity.

The circuit in FIG. 10 is the complete power management circuit. It includes the configurable voltage amplification and rectification circuit from FIG. 6, configurable boost converter in FIG. 14 and configurable voltage conversion that is formed by the circuit in FIG. 14, the buck converter and the converter mode controller in FIG. 10.

Given that wireless sensor nodes usually require a supply voltage of 2-3.6 V to operate, different dc-dc converters (buck/boost converters), which will be determined by the converter mode controller are used to convert V_{rect} that ranges from 0.35-20 V. A boost converter (bq25504) and a buck converter (LTC3388-3) are used when V_{rect} is lower and higher than the voltage required by the wireless sensor node, respectively. The boost converter comes with its own fractional open-circuit voltage maximum power point tracking (MPPT). The MPPT circuit in was adopted for the buck converter and the EAI was adopted from. The harvested energy is stored in Cₛₜₒᵣ and the energy usage is managed by the EAI. Three diodes D_{O1-3} form a ORing among the dc-dc converters and the start-up circuit to supply the circuits with the highest voltage V_{CC}. As V_{PZ} can be very high, V_{rect} is scaled down using a resistive divider to different ratios as reference voltages V_{RD-C} and V_{RD-R}, which is conditioned as V_{CN} for reconfiguring the circuit.

FIG. 11 shows a flow chart detailing the operation of the circuit from FIG. 10 according to an embodiment.

At step S100, the voltage from the PEH is output. The voltage is V_{PZ}, or even V_{g}. The two parameters may be used interchangeably with reference to FIG. 11. At Step 102, V_{g} is compared to 0.35 V. If V_{g} is less than or equal to 0.35 V, the circuit does not operate. Once V_{g} is greater than 0.35 V, the operation moves to Step S104. At step S104, V_{g} is compared to 5.5 V. If V_{g} is less than or equal to 5.5 V, the mode is VD as shown by step S106. In this case, the voltage V_{g} is compared to 3.3 V in step S108. If V_{g} is less than or equal to 3.3 V, the operation moves to step S110, where V_{S} is compared to V_{g}. If V_{S} is less than or equal to V_{g}, direct charging is used at step S112. Finally, the capacitor Cₛₜₒᵣ is charged at step S114. Alternatively, if V_{cs} is found to be greater than V_{g} at step S112 then the boost converter is used at step S120 prior to charging the capacitor in step S114

However, if at step S104, Vg is greater than 5.5 V, the full-wave bridge rectifier (FR) is use at step S116. Subsequently. The buck converter is used at step S118, prior to charging the capacitor at step S114. The buck converter is also used at step S118 if Vg is found to be greater than 3.3 V in step S108, prior to charging the capacitor at step S114.

In this way, the default topology is voltage doubler (VD) and boost converter. The circuit switches to buck converter if the rectified voltage exceeds 3.3 V. The circuit switches to full-wave rectifier if the rectified voltage exceeds 11V (voltage from energy harvester is 5.5 V as it has been amplified by the voltage doubler).

It will be appreciated that while the foregoing specific voltage values have been used, other voltage values can be used instead without falling outside of the scope of the invention.

FIG. 12 shows a flow chart of the circuit operating according to another embodiment. At step S200, the energy harvester outputs a voltage Vg (or VPZ). If the voltage Vg at step S202 is less than 0.25 V, the active rectifier is not activated and energy flows through the passive rectifier diodes, as per step S204. This happens until Vg is greater than or equal to 0.25 V at step S202. In this event, at step S206, the start-up circuit can provide sufficient voltage to active rectifier, i.e. the active rectifier is enabled at step S206.

If the voltage Vg is less than 11 V, at step S208, the voltage doubler VD is used at step S210. The voltage doubler is used until, at step S208, Vg is greater than or equal to 11 V. At this stage, the full-wave rectifier is used at step S212. If Vg is greater than or equal to 3.69 V at step S214 then the full-wave rectifier is continued to be used. However, if at step S214 Vg is less than 3.69 V, the voltage doubler VD is used as per step S210.

FIG. 13 shows a system including the power management circuit and energy harvester of any of the embodiments described herein together with a step-up converter and a capacitor used to store the harvested charge. It will be appreciated that the system is a configurable charging system that incorporates directed charging of a capacitor via an energy harvester to over 75% open-circuit voltage of the energy harvester before switching over to charge up the capacitor using the step-up converter. The step-up converter may be a conventional step-up converter and so we refrain from describing it here for brevity since a skilled person would be aware of its construction and operation.

The direct charging method may have an equivalent energy transfer efficiency of 81%. If the open-circuit voltage of an energy is higher than the minimum operating voltage where all the circuit functionality such as MPPT is activated, the circuit will switch over to use a dc-dc converter to charge the capacitor as the efficiency can by up to 90%.

In more detail, FIG. 13 shows an energy harvester that charges a capacitor C directly and via a step-up converter. The switch between charging directly and charging by the step-up converter is based on comparison of the open-circuit voltage of the energy harvester to a threshold. The threshold may be 75%, for example. The energy harvester is represented by a voltage source with an open-circuit voltage Voc. And a serial resistor R as enclosed by the dashed line. When C is charged up directly by the energy harvester, the voltage v_{c} across the current I_{c} flowing into the capacitor are given by (6) and (7), respectively.

V_{c}(t)=V_{oc}[1−exp(−t/RC)] (6)

i_{c}(t)=[v_{oc}/R][exp(−t/RC)] (7)

The capacitor energy equation E=CV²/2 shows the voltage across a capacitor can be related to the energy stored in C. By substituting (6) into the equation, the energy can be expressed as (3) and its differentiation yields (8), which is the power.

e(t)=[CV_{oc}²/2][1−exp(−t/RC)]² (8)

p_{c}(t)=[V_{oc}²/R][exp(−t/RC)−exp(−2t/RC)] (9)

p_{c} gradually increases and reaches its peak as given by (10) at t=RCIn2 where V_{c}=V_{oc}/2, before falling off again.

P_{c(peak)}=V_{oc}²/4R (10)

When a capacitor is charged up via a step-up dc-dc converter, the output voltage of the energy harvester is always lower than the V_{OC} of the energy harvester by a fraction of N at its maximum power point (MPP) for maximum power transfer. The output voltage of a solar cell is usually 0.7-0.8 of its V_{OC} while other types of energy harvesters such as PEH and TEG is 0.5 at their MPP [3-5]. Thus, the output voltage of the energy harvester is V_{OC}/N where N is a real number of larger than 1. Maximum power transfer occurs when the equivalent resistance of the dc-dc converter matches R of the energy harvester. Thus, the dc-dc converter has an input current of V_{OC}/2R and the maximum input power Pᵢ as given by (11):

Pᵢ=V_{oc}²/(2NR) (11)

Some power will be consumed by the dc-dc converter before being transferred to the capacitor. With a given efficiency η_{dc}, a dc-dc converter outputs the power Pₒ as given by (12) to a capacitor. The energy stored in the capacitor is given by (13).

Po=η_{dc}Pᵢ=η_{dc}V_{oc}²/(2NR) (12)

Eₒ=∫Pₒdt (13)

Assuming that N=2, this gives an output voltage of V_{OC}/2, which is the MPP for many types of energy harvesters. In this case, Pᵢ=P_{c(peak)}=V_{OC}²/4R. If the dc-dc converter transfers power from the energy harvester at MPP all the time, Pₒ will be constant as shown in Fig. If the converter efficiency η_{dc} is taken into account, the horizontal line of Po would be at the same level as the numbers on the y-axis. For example, Pₒ at 0.8, 0.6, and 0.4 corresponds to the efficiencies of 80%, 60%, and 40%, respectively. Substituting t of RCIn2, 2RCIn2, and 3RCIn2 into (8) yields RCPᵢ/2, 9RCPᵢ/8, and 49RCPᵢ/32, respectively. Assuming that η_{dc}=100% and substituting the same set of t into (13) yields RCIn2Pᵢ, 2RCIn2Pᵢ, and 3RCIn2Pᵢ, respectively. Comparison of the two sets of theoretical results shows that direct charging of a capacitor is equivalent to using a dc-dc converter with the efficiencies of 72.13%, 81.15%, and 73.64% at the t of RCIn2, 2RCIn2, and 3RCIn2, respectively.

FIG. 14 shows the proposed system architecture to realise adaptive direct charging of a capacitor. It has a multiplexer for connecting either the energy harvester or the step-up converter to the capacitor and a control circuit for selecting the charging method. The multiplexer has two inputs where they are each connected to the output of an energy harvester and the output of a step-up converter. When the control circuit outputs a LOW signal to the input selector of the multiplexer, the output of the multiplexer comes from the energy harvester. When the signal turns HIGH, the output is from the step-up converter. Since the direct charging has a theoretical limit of around 81% and boost converter can operate at a higher efficiency of over 80% when V_{c} reaches the minimum operating voltage of its controllers for functionality such as MPPT enabled, the EAI sends a HIGH signal to switch the multiplexer via a diode D_{S2}, which forms an ORing with D_{S1} for the output from the comparator. An energy storage capacitor C is connected to the output to be charged by either input of the multiplexer. The circuit design is simple for a low power consumption, which is essential to maximize the energy transferred to the capacitor. The input of the step-up converter is connected to the energy harvester so that it can still step-up the voltage as the supply to the circuit.

The key design is to determine the time to switch from direct charging to using a step-up converter. An RC based filtering technique is used to determine the switching time. V_{g} is fed to a high-pass (HP) filter and the voltage across capacitor V_{C} is fed to a low-pass (LP) filter. Their outputs as given by (14) and (15) where V_{g}=V_{C} during the direct charging phase, τ=RC, τ_{HP}=R_{HP}CH_{P}, and τ_{LP}=R_{LP}C_{LP} are connected to the negative and positive inputs of a comparator, respectively.

$${v}_{HP} ( t ) = {v}_{c} ( t ) exp ( - t / {τ}_{HP} ) = \vert {V}_{oc} \vert [ 1 - exp ( - t / τ ] [ exp ( - t / {τ}_{HP} ) ] \qquad ( 14 )$$

$${v}_{LP} ( t ) = {v}_{c} ( t ) [ 1 - exp ( - t / {τ}_{LP} ) ] = \vert {V}_{oc} \vert [ 1 - exp ( - t / τ ) ] [ 1 - exp ( - t / {τ}_{HP} ) ] \qquad ( 15 )$$

Initially, V_{g} is higher than V_{C} as the switch of the multiplexer a higher resistance, especially during transient where the switch is yet to be fully turned on. Therefore, V_{HP} at the negative input is higher than V_{LP} at the positive input, which ensures the output signal S from the comparator is LOW at the beginning of the system operation regardless of the voltage level V_{SU} to the comparator. As V_{HP} and V_{LP} started to crossover each other where V_{HP} becomes lower than V_{LP}, signal S becomes HIGH to switch the output of the multiplexer to be from the step-up converter. The time that the amplitude of V_{HP} and V_{LP} becomes equal is the time to switch from direct charging to using a step-up converter. Let τ_{HP}=τ_{LP}=τ_{F} and equating (14) and (15) yields the switching time t_{SW} as given by (16). From the analysis in previous section, t_{SW} should be around 2RCIn2. Thus, the time constant of the filters directly links to t_{sw} where a τ_{F} of 2RC means the switching time occurs at 2RCIn2.

Tsw=τ_{F}In2 (16)

FIG. 16 shows the profiles of V_{C}, V_{HP} and V_{LP} with different time constants. When τ of the equivalent circuit formed by the capacitor C and the impedance of the energy harvester is RC and the time constant of the filters τ_{F}=21, V_{HP} and V_{LP} cross each other at t=2τIn2, which occurs at V_{C}=0.75V_{OC}. If τ_{F}=10τ, V_{HP} and V_{LP} as marked by ∘ and □, respectively cross each other at around t=10τIn2. This shows that the switching time can indeed be easily controlled by the parameters of the filters. If the resistance of the energy harvester does not vary by more than 10%, τ_{F} can be designed to be 2τ. If the resistance has a larger variation, for example, increases by 5 times, τ becomes 5R_{C}. Although the voltage profiles changed, the time that V_{HP} and V_{LP} cross each other only changed slightly. The time is still mainly determined by τ_{F}. If τ_{F} was set to be 2τ, the switching time would be too early for the case when the energy harvester has a higher resistance, which resulted in a low energy transfer efficiency. Setting τ_{F} to a higher value to suit the case when the energy harvester has a higher resistance might not be ideal for the case when the resistance of the energy harvester is low but it would give an overall higher energy transfer efficiency for both cases. Thus, it is recommended to use a τ_{F} that is equal to τ of the case when the energy harvester has the highest resistance.

When energy is harvested at half of the open-circuit voltage of most energy harvesters (except solar panel), maximum power can be transferred. FIG. 17 illustrates a voltage profile across a capacitor V_{c} that was charged by a voltage with the amplitude of V_{oc}, the derivative of V_{oc}, and the multiplication of the V_{c} and its derivative. Referring to FIG. 17, this method finds the half open-circuit voltage using the following principle.

$${V}_{C} = {V}_{OC} ( 1 - {e}^{- \frac{t}{RC}} ) \qquad ( 17 )$$

$$\frac{{dV}_{C}}{dt} = \frac{{V}_{OC} {e}^{- t / RC}}{RC}$$

$${V}_{C} \times \frac{{dV}_{C}}{dt} = \frac{{V}_{OC}^{2}}{RC} ( {e}^{- \frac{t}{RC}} - {e}^{- \frac{2 t}{RC}} ) )$$

Differentiate the equation (17) and equate it to 0 to find the time that

$${V}_{C} \times \frac{{dV}_{C}}{dt}$$

reaches its peak value. This occurs at t=RCIn2.

By substituting t into

$${V}_{C} = {V}_{OC} ( 1 - {e}^{- \frac{t}{RC}} )$$

results in V_{c}=V_{oc}/2.

The above analysis shows that

$${V}_{C} \times \frac{{dV}_{C}}{dt}$$

reaches its peak when V_{c} is at half of its open-circuit voltage, which corresponds to the voltage for maximum power transfer to occur.

designed to operate when sufficient energy has been accumulated in the energy storage device. In the case of railway application, there is a requirement for the system to start operating whenever there is a train on the rail track. However, energy is only available for harvesting when a train is on the rail track. Using a conventional energy harvesting powered system architecture would mean that the system is unlikely to operate when there is a train on the rail track as the system is still harvesting and accumulating energy at that time. There were some reported work on multi-energy storage devices for energy harvesting powered systems but the focuses were to: Reduce common-mode failure with each subsystem having its own energy storage. This is because each subsystem has a different voltage and power requirement. Using a single energy storage device will limit the whole system operation to the subsystem that has the highest energy and voltage requirement. Provide sufficient energy by connecting multiple energy storage devices in parallel or a sufficiently high voltage by connecting multiple energy storage devices in series to the systems to achieve specific tasks such as data transmission (high power required) and start-up (high voltage required).

According to an embodiment, these issues are addressed by incorporating two or more (a plurality of) energy storage devices in the energy harvesting power system to enable simultaneous accumulation of the harvester energy for the next operation in one energy storage device and another energy storage device to power up the system for current operation.

FIG. 18 shows three figures (a) to (c). FIG. 18 a) shows an overall system architecture. FIG. 18 b) shows a voltage at the energy storage devices. FIG. 18 c) shows current consumption of the controller.

The controller consumes less than 18 nA to ensure that this added complexity has negligible effect on the overall system.

FIG. 19 shows a circuit diagram of a wake-up circuit according to an embodiment.

A wireless sensor node is usually in sleep mode and is only required to operate at full capability where all the sensors and radio are fully powered on when an event, for example, a train is approaching is detected to conserve energy. A wake-up circuit, which detects an event and wakes up the wireless sensor node is required for this purpose. Conventional wake-up circuit operates based on a simple fixed threshold but using a fixed threshold is ill-suited for real-world application because the signal received by the wake-up circuit may vary due to several factors. Those factors include the sensitivity of the transducer used to generate the signal. In addition, the location where the circuit installed is a factor. Another factor is the cause or nature of the event as the circuit cannot discriminate the patterns of events. Finally, the wake-up circuit will not respond if the threshold voltage is too high and will give a lot of false wake-up signal if the threshold voltage is too low.

Many mechanisms are proposed to make threshold-based wake-up circuits work for real-world applications. For example, multilevel optimisation that includes three levels of signal processing from algorithm level, architecture level and circuit level. In addition, it is possible to configure a set of predetermined levels of thresholds at algorithm level using software simulation. Further, a Neural Network can be trained to determine the coefficient for different signals. A circuit can digitalise the input signal and compare the output with the thresholds. Multiple thresholds can be compared from the signal amplitude, pulse width and time interval between successive signals. Discrete Fourier Transform can be performed on one frequency band at a time and then switches to another band to obtain coefficients as reference voltages that allow the wake-up circuit to compare with the input signal and determine whether the signal is within the range of interest. Although these circuits were reported to consume very low power of between 12 and 148 nW, they are relatively complex to implement and still require some predetermined values from known signal sources to set the operation of the circuit.

With reference to FIG. 19, the wake-up circuit 600 includes an envelope detector 602, a slope detector 604, and a wake-up pulse generator 606. The wake-up circuit 600 exhibits performance benefits including relatively constant current consumption of about 250 nA regardless of input signal frequency. In addition, the wake-up circuit 600 has high sensitivity with even when the input voltage is in the range of tens of millivolts. The envelope detector captures the profile of the changes of the input voltage from sensor connected to it. The slope detector tracks the changes of the profile and provides an output that is proportional to the gradient of the slope. The wake-up pulse generator then converts the output from the slope detector to a digital pulse as a signal to wake-up the wireless sensor system.

With reference to FIG. 20, the current consumption of the wake-up circuit 600 is shown compared to vibration frequency (Hz). It can be seen that current consumption is substantially constant.

FIG. 21 shows three different profiles of how the circuit responds to a) increasing angle of inclination, b) decreasing angle of inclination, and c) decreasing angle of inclination with very low amplitude of less than 100 mV.

Whilst specific embodiments of the invention are described hereinbefore it will be appreciated that a wide range of modifications or alterations may be made thereto without departing from the scope of the invention as defined by the appended claims.

1. An energy harvesting device comprising a piezoelectric material element, a proof mass moveable relative to the piezoelectric material element and coupled to the piezoelectric material element by a coupling arrangement such that movement of the proof mass causes compression of the piezoelectric material element, wherein the proof mass defines a cavity, the piezoelectric material element being located, at least in part, within the cavity.

2. A device according to claim 1, wherein the centre of mass of the proof mass is aligned with the piezoelectric material element, in the direction of movement of the proof mass.

3. A device according to claim 1, wherein the coupling arrangement comprises a first and second linkages coupled to the proof mass and coupled to respective compression members located to opposing ends of the piezoelectric material element.

4. A device according to claim 1, wherein the manner in which the proof mass is coupled to the piezoelectric material element is such that, throughout the permitted range of movement of the proof mass, the piezoelectric material element is under compression.

5. A device according to claim 4, wherein the harvesting device includes first and second clamp members between which the piezoelectric material element is located, the first and second clamp members being coupled to one another by a coupling element applying a clamping load to the clamp members to pre-stress the piezoelectric material element, placing the piezoelectric material element under compression throughout the range of movement of the proof mass.

6. A device according to claim 1, wherein the energy harvesting device further comprises a housing within which the proof mass and piezoelectric material element are located.

7. A device according to claim 6, wherein the proof mass is supported within the housing by resilient spring means.

8. A device according to claim 6 when dependent directly or indirectly upon claim 3, wherein further linkages are provided between the compression members and a part of the housing.

9. A device according to claim 1, further comprising a compressible damper member to damp movement of the proof mass when the proof mass moves beyond a predetermined point.

10. A power management circuit comprising a configurable voltage amplification and rectification circuit and a mode control circuit operable to configure the configurable circuit to operate in a voltage amplification mode or in a rectification mode, the mode control circuit selecting the operating mode depending upon the input or output of the configurable circuit.

11. A circuit according to claim 10, wherein the mode control circuit selects the operating mode depending upon the output of the configurable circuit.

12. A circuit according to claim 11, wherein where the circuit output is below a predetermined threshold then the mode control circuit configures the configurable circuit to operate in the voltage amplification mode, and where the circuit output is greater than the predetermined threshold then the mode control circuit configures the configurable circuit to operate in the rectification mode.

13. A circuit according to claim 10, wherein in the voltage amplification mode, the configurable circuit is configured as a voltage doubler.

14. A circuit according to claim 10, wherein in the rectification mode the configurable circuit is configured as a full wave rectifier.

15. A circuit according to claim 14, wherein in the rectification mode the configurable circuit is configured as an active full wave rectifier.

16. A circuit according to claim 10, wherein the configurable circuit is further configurable as a passive full wave rectifier.

17. A system comprising:
an energy harvesting device comprising a piezoelectric material element, a proof mass moveable relative to the piezoelectric material element and coupled to the piezoelectric material element by a coupling arrangement such that movement of the proof mass causes compression of the piezoelectric material element, wherein the proof mass defines a cavity, the piezoelectric material element being located, at least in part, within the cavity; and
a power management circuit comprising a configurable voltage amplification and rectification circuit and a mode control circuit operable to configure the configurable circuit to operate in a voltage amplification mode or in a rectification mode, the mode control circuit selecting the operating mode depending upon the input or output of the configurable circuit,
wherein the power management circuit is configured to rectify an output of the energy harvesting device.

18. A system of claim 17, further comprising a storage capacitor, wherein the power management circuit is configured to charge the storage capacitor.

19. A system of claim 18, further comprising a step-up converter, wherein the power management circuit is configured to charge the storage capacitor by direct charging when an open circuit voltage of the energy harvesting device is below a threshold and the step-up converter is configured to charge the storage capacitor when the open circuit voltage of the energy harvesting device is greater than or equal to the threshold.

20. A system of claim 19, wherein the power management circuit is configured to charge directly the storage capacitor at around 75% of the peak open-circuit voltage of the energy harvesting device.

21. A system of claim 18, further comprising a further storage capacitor, wherein the system is configured to charge one of the storage capacitor and the further storage capacitor in response to the other of the further storage capacitor and the storage capacitor being discharged by a load.

22. A system of claim 17 further comprising an analogue based wake-up circuit.
